(19) United States
(12) Patent Application Publication
(10) Pub. No.: US 2002/0161686 A1
(43) Pub. Date: Oct. 31, 2002

(54) Computer system and method for securing market profits of financial instrument investments

(76) Inventors: Burghard Stover, Bremen (DE); Wilhelm Berghorn, Bremen (DE)

Correspondence Address: SCHIFF HARDIN & WAITE, 6600 SEARS TOWER, 233 S WACKER DR, CHICAGO, IL, 60606-6473, US

(21) Appl. No.: 10/074,927

(22) Filed: Feb. 12, 2002

(30) Foreign Application Priority Data
Feb. 19, 2001 (EP) 01103549.0

(51) Int. Cl. G06F 17/60

(52) U.S. Cl. 705/36

(57) ABSTRACT

Computer system is provided for securing market profits of financial instrument investors having a mechanism for electronic storing of a yield target for a purchased species of stock or security, a mechanism for electronically acquiring the current rate of the stock or security species, a mechanism for calculating the yield and comparing the calculated yield to the yield target, where the mechanism for calculating and comparing is configured such that, if necessary, they implement one or more recalculations and recomparisons with rates newly acquired by the means for electronically acquiring the current rate until the calculated yield is higher than the yield target. Additional computations and comparisons are done to optimize the invention.

### BACKGROUND OF THE INVENTION

1. Field of the Invention

The present invention is directed to a computer system and method for securing market profits of financial instrument investments.

2. Description of the Related Art

Profit-taking refers to the sale of financial instrument investments (the term “financial instrument” or “instrument” used here and throughout refer to stocks and/or other financial securities) that secure the market profits achieved after a rise in prices in order to convert these profits into hard currency.

It is currently standard for banks or brokers to declare a (usually time-limited) fixed stop rate. Given rising instrument rates, this must be permanently worked out by self-initiative of the bank or broker customer (an instrument investor) or on the basis of respective consultation of the bank or of the broker with the customer. When no adaptation takes place and the instrument rates again drop down to the (fixed) stop rate, the sale of the instrument is only triggered by rates hitting this stop rate, resulting in not realizing the paper profits that were achieved in the meantime.

### SUMMARY OF THE INVENTION

The present invention is thus based on the object of securing market profits without requiring consultation with the customer and without complex customer self-initiative.

This object is inventively achieved by a computer system for securing market profits of financial instrument investors having:

a mechanism for electronic storing of a yield target for a purchased species of financial instrument,

a mechanism for electronically acquiring the current rate of the instrument species,

a mechanism for calculating the yield and comparing the calculated yield to the yield target,

where the mechanism for calculating and comparing is configured such that, if necessary, it implements one or more recalculations and recomparisons with rates newly acquired by the mechanism for electronically acquiring the current rate until the calculated yield is higher than the yield target,

where the mechanism for calculating is also configured such that, given the first-time and every further occurrence of this situation, it effects storing the calculated yield target as a new yield target in the mechanism for electronically storing a yield target and, if necessary, implements one or more recalculations until the calculated yield is lower than the respective, new yield target and does not lie within a tolerance value,

the computer system also having a mechanism for outputting an instruction to sell the instrument species when the calculated yield is lower than the (new) yield target and does not lie within a tolerance value.

The invention targets, as the consideration time span, the point in time of purchase or the first point in time of purchase. The invention also establishes a stop rate as a result of a maximum of the rate course after a yield target has been reached, minus a tolerance value.

The object of the invention is also achieved by a method for securing market profits of instrument investors using a computer, the method comprising the following steps:

a) electronically storing a yield target for a purchased instrument species;

b) electronically acquiring the current rate of the instrument species;

c) calculating the yield and comparing the calculated yield to the yield target and, when the calculated yield is lower than or of the same size as the yield target, repeating the steps beginning with step b);

otherwise

a′) electronically storing the calculated yield as a new yield target;

b′) electronically acquiring the rate of the instrument species;

c′) calculating the yield and comparing the calculated yield to the new yield target, and

repeating Steps a′) through c′) when the calculated yield is higher than the new yield target,

retaining the yield target and repeating the steps beginning with Step b′) when the calculated yield is lower than the new yield target but lies within a tolerance value, and

outputting an instruction to sell the instrument species when the calculated yield is lower than the new target yield and does not lie within a tolerance value.

This object is also achieved by a computer program having program code that implements the inventive method on a computer. This object is also achieved by such a computer program that is stored on a computer-readable data carrier.

The computer system can be configured to output an instruction to sell only when a predetermined time interval following the purchase has elapsed.

The mechanism for calculating the yield and comparing the calculated yield to the yield target can also be configured to calculate an annualized yield, where this annualized yield may be calculated either with respect to the purchase price of the purchased instrument species or the average annual yield for run times that are shorter than one year.

According to a preferred embodiment of the invention, the computer system may be configured to calculate an instrument index for the instruments of a customer deposit, where these calculations can provide that the index curve is steady given a purchase or sale of an instrument. This calculation for calculating the yield and comparing the calculated yield to the yield target may be configured to access the index curve as a test criterion. The prescribed minimum corresponds to a “stop loss rate” for limiting market losses.

When a speculation term is considered, then an instruction to sell (sell signal) for a profit-taking is only output when a predetermined time interval, i.e., the speculation term, has elapsed since the purchase of the appertaining instrument.

According to another, particular embodiment of the invention, the computer system is configured to check whether a prescribed minimum of the rate curve has been reached, and can output a sell signal when the minimum has been reached.

In another particular embodiment of the invention, the computer system is provided with data bank for the input and, potentially, storing the following stock attributes:

purchase price,

time of purchase;

number of units;

absolute yield target;

annualized yield target;

checking the yield target with reference to an instrument index;

maximum of the rate curve after the yield target has been reached; and

prescribed minimum of the rate curve.

These attributes can take into consideration a speculation term, where the mechanism for determining a maximum of the rate curve is provided for access onto the data bank in order to store a maximum of the rate curve.

The mechanism for doing this is a component part of a computer.

Beneficially, the invention also contemplates a server computer for offering instrument quotes and a server computer for outputting sell orders that are connectible to the computer via a network.

The computer system may also include:

web generation utilities for providing a user interface;

user groups storage facilities via which access rights are assigned to each user; and

an administrator user function where the storage facilities are configured to permit the administrator to enter the users of a user group and their access rights.

The computer system may further include:

a customer data entry system by which each customer is assigned to a pair of users of the same user group;

a contract data entry system by which each contract is assigned to a pair of users of the same user group;

an automatic processing status generator for the customer data and the contract data; and

a work list generator that is based on the processing status for each of the users.

These elements are preferably a component part of a server computer.

An application service provider (ASP) server computer is especially preferred. In this case, the computer system can be used by different financial providers such as estate management companies or banks. The ASP server computer preferably has a data bank system that promotes internal communication, communication with the customer and the required administration sequences.

According to a preferred embodiment of the invention, such a data bank system offers the possibility of acquiring the master data from different companies, e.g., estate management companies and banks. Furthermore, this data bank system may serve the purpose of acquiring the appertaining employees and their respective access rights.

Preferably, at least one employee of a company has the role of a “company administrator” that, among other things, gives the appertaining employee the right to input employee data and assign access rights. The company administrator is input by an administrator of the ASP server computer.

The data bank system also preferably acquires master data of the customers as well as deposit data and the parameters for securing the system (contract data, i.e., yield target, tolerance, stop loss rate, etc. that are contractually declared between consumer and consultant) relating to individual securities. Each customer and each contract is assigned to a team of users of the appertaining county, i.e., a pair of users. This allocation the size about the competence of processing, for example, sell signals.

According to another preferred embodiment of the invention, a work list is generated for each user, where this generation is based on status information allocated to the contracts and the customers.

The data bank system thus allows an effective, computer-supported work sequence for the customer and contract administration. It is particularly advantageous that the “four eyes principle” is supported by the system, i.e., that an entry is reported by an employee and is monitored and confirmed by a higher-ranking entity. This implies that entries always have at least two statuses: reported and confirmed. When an event is only reported, then this event is in fact stored in the data bank but is not processed by the system. An event can be processed by the system as soon as it is confirmed.

When, for example, a consultant has a first customer conversation, he reports the appertaining master data of the customer. For example, fund investments are offered in this first customer conversation. This consultation will usually be followed by a request to conclude a fund investment that must yet be confirmed in a further step. The consultant now reports the master data of the customer in the system. These data contain the attribute “reported” and can thus be interrogated (for example, for sending general product information).

After the logon, these master customer data are reported to the company administrator in the system, with the request to check as well as with request of a confirmation. When the company administrator corrects the master data and/or confirms them, then this customer dataset is identified with a “confirmed” attribute in the internal data bank. From this point in time, contracts, etc., can also be assigned to this customer. The customer is listed at the company administrator with the request for confirmation until the administrator outputs the confirmation.

If the customer wishes to conclude a contract with the consultant company represented by the consultant regarding the securing of an investment, then a corresponding contract is reported in the data bank. In this work execution, the consultant can also print out the necessary forms for the customer. The contract is thus considered (as identified in the data bank) “requested”. Such a request is signed by the consultant and by the customer and only takes effect on the basis of a third signature of the company administrator. In addition to the signature, the company administrator must likewise confirm the requested contract in the system. From this point in time, the confirmed contract is monitored in the data bank.

When a contract is noted by the customer, then the account manager or consultant will report this noting in the system. The customer's noting then appears together with the request for confirmation at the associated consultant, who confirms the noting. A form letter can be printed out in the process of the log on by the account manager, and the letter can be presented to the consultant for signature. The corresponding contract is deleted from the data bank with confirmation of the customer's noting.

When a sell signal is generated by the computer system, i.e., the fund shares are marked to be sold, then this is reported to the account manager by the system. The account manager or consultant prints out a corresponding form for notifying the customer a well as the existing sales request (digitally stored) and submits this to the customer consultant for signature. The corresponding sell order is reported by the account manager. This application is confirmed by the consultant and the sale is initiated.

Due to the deletion of an employee (consultant), associated contracts (i.e., the contracts between final consumer and consultant that contain the securing parameters for an investment) must be assigned to a different employee. To achieve this, the deletion of the employee is suppressed until every individual contract has been assigned to a different consultant.

In general, contracts and customers are handled by teams. Teams are pairs of employees of a firm that are composed of a consultant and an account manager. These teams are assigned to every contract and customer. Every change in status of a customer or of a contract is co-logged by a change of the attributes of the corresponding object. This permits replication at any time of who elicited specific status changes.

As a result of the ASP approach, the connected companies or consultants require only a slight infrastructure (e.g., a computer, browser, and/or Internet connection) in order to be able to work with this computer system. Moreover, a plurality of employees (users of the computer system) can work in parallel on the same customer and contract inventory individually or in the team. This assures that different members of a team can efficiently implement the tasks given a multitude of contract applications or contract notings.

This also assures, due to the imaging of the work flow of the consultant, that the concluded contracts with the customer are represented as closely as possible by the data bank contents.

The selected ASP approach is particularly advantageous since the connected consultants or companies need comprise only a slight infrastructure in order to be able to be connected to the system. Furthermore, the participants in this system can log on from any arbitrary location (presuming a terminal and Internet connection). This additionally permits giving the final consumer of the connected consultants access to the current deposit values and yields achieved as well.

The following aspects are especially advantageous:

The various combinations of the contracts allow a greater flexibility in the investment of the customer assets. Furthermore, these security parameters are not limited in time as is generally standard.

The possibility of forming teams of an account manager and consultant corresponds to the standard procedure in larger consulting companies. As a result of this system functionality, the work can be divided among the team members.

By introducing access rights, it becomes possible to transfer specific responsibilities that, for example, exist in a consulting company directly into the system.

The advantages of the four-eyes principle (i.e., the necessity of confirmation by the company administrator given business-relevant events) is that the company administration or company management is always informed about changes in the customer or contract inventory and can also consult here with the participating consultants. This functionality of the system achieves a great transparency regarding the customer set but also regarding the contracts that have been concluded as well as their progress.

The imaging of the work flow given consultations in the system permits the respective relationships or contract statuses with the customer to be imaged as closely as possible. Thus, for example, when a contract is selected for the customer, a printout of the necessary forms may be simultaneously prepared. As soon as a contract is signed by the customer, this is reported in the system and presented to the company management for signature. The company management/company administration should confirm this contract parallel to the signature. The contract can thus only be activated when this has been enabled or signed by the company administration.

Expediently, the invention may provide a server computer for offering instrument rates and a server computer for outputting sales contracts, such server computers being connectible to the ASP server computer via a network.

Advantageously, the invention may provide at least one computer of a bank or the like that is connectible to the ASP serve computer via a network.

Finally, the ASP server computer can be designed such that at least one customer of the bank or the like can communicate directly via the network with the ASP server computer.

An inventive method is also described below.

The invention is based on the nonobvious realization that, due to the specific rate monitoring and interpretation, consultation with the instrument investor or, respectively, a complex self-initiative of the investor are not required. An interaction between the customer and the customer's bank or broker is thus superfluous, as is an external data bank access. On the contrary, the adaptation is fully automated using the inventive computer system without an requiring an external data bank access and the setup of a data transmission.

The indication to sell (sell signal) can be electronically output, for example, on a picture screen, so that the bank consultant or broker and/or the customer himself can take note of the sell recommendation. The electronic output of the sell signal can take place, for example, in the form of an electronic message (e.g., an e-mail or work list). Alternatively or additionally, the sale can be fully automatically sequenced on the basis of the sell signal in that, for example, a corresponding sell order is generated by the computer system and is communicated via a dataline to the appertaining fund corporation or to an on-line broker.

### DESCRIPTION OF THE DRAWINGS

For the purposes of promoting an understanding of the principles of the invention, reference will now be made to the preferred embodiments illustrated in the drawings, and specific language will be used to describe these embodiments. No limitation of the scope of the invention is intended by this specific language, and the invention should be construed to encompass all embodiments that would normally occur to one of ordinary skill in the art.

FIG. 1 is a block diagram showing a first embodiment of an inventive computer system for commerce with securities;

FIG. 2 is an exemplary data structure diagram of the customer data bank for the computer system of FIG. 1;

FIG. 3 is a graph illustrating an embodiment of the inventive method on the basis of a rate course; and

FIG. 4 is a block diagram showing an embodiment of an inventive computer system for commerce with securities having an ASP server computer.

### DETAILED DESCRIPTION OF THE INVENTION

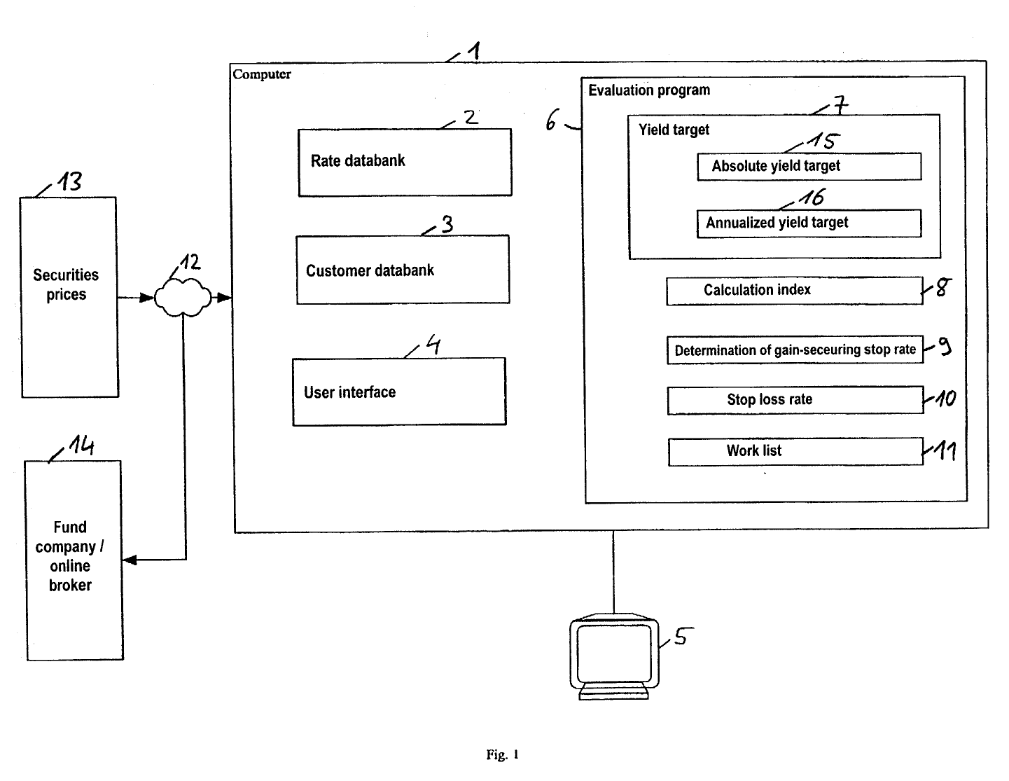

FIG. 1 shows a computer system with a computer 1 having a rate databank 2 and a customer databank 3. The rate databank serves for storing current security rates that are required for the evaluation.

The master data of a customer as well as one or more security identifiers of the customer deposit are stored in the customer databank 3. The customer can specify for a specific security whether to monitor an absolute yield target or an annualized yield target, namely with reference to the rate course of the appertaining security or with reference to a customer deposit index.

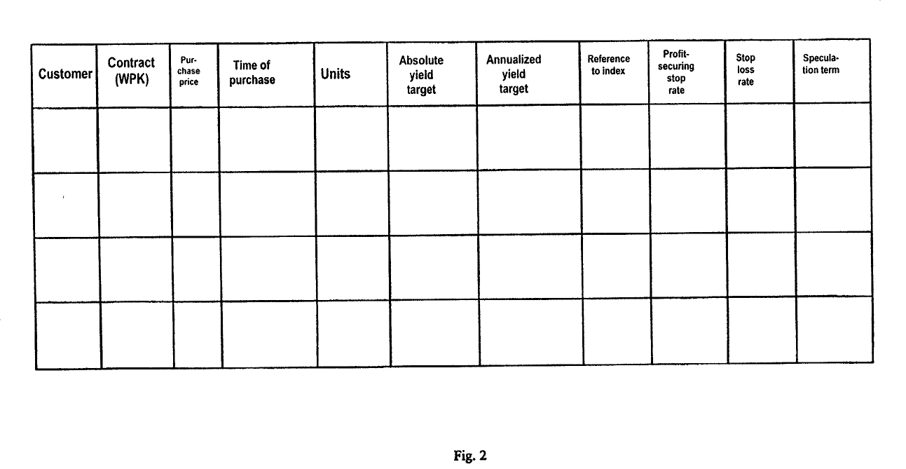

Additional entries into the customer databank 3 can include whether the customer wishes a profit securing stop rate for securing market profits and how great the potential tolerance value is. Furthermore, a stop loss rate as well as the observation of a speculation term can also be optionally input. A preferred embodiment of the customer data bank 3 is explained in greater detail below with reference to FIG. 2.

The input of the data into the customer data bank 3 may ensue via a user interface 4 that, for example, is made available by the operating system of the computer 1 and enables inputs as well as outputs via monitors 5 connected to the computer 1.

The computer 1 may also have an evaluation program 6 with a program module 7 for checking whether a yield target has been achieved, a program module 8 for calculating a customer-specific security index, a program module 9 for determining the profit securing stop rate, a program module 10 for monitoring when the stop loss rate is reached, and a program module 11 for generating a work list that, for example, indicates sales to be undertaken.

The computer 1 may be connected via a network 12 (e.g., the Internet or telephone network) to a server computer 13 from which current security prices can be fetched. Furthermore, the computer 1 may be connected via the network 12 to a server computer 14 of a fund corporation or an online broker in order to activate cell orders. Alternatively, for a server computer, for example, a fax machine can also be present at the side of the fund corporation in order to be able to accept sell orders communicated via fax.

During operation of the computer 1, the current security prices of the securities covered in the customer data bank 3 are interrogated by the server computer 13 via the network 12 and are stored in the rate data bank 2. The evaluation program 6 then accesses the rate data bank 2 in order to evaluate the rate curve according to the customer prescriptions stored in the customer data bank 3.

The program module 7 then automatically checks whether the desired yield target has been achieved. When the customer has prescribed the achievement of an absolute yield target, the program module 15 is started; when, in contrast, an annualized yield target has been prescribed by the customer, the program module 16 is started. It is also a determining factor for the type of calculation of the yield as to whether the customer wishes the yield calculation related to an individual stock or related to the index course of his customer deposit.

The program module 15 is started, i.e., when a check is carried out to see whether the rate course or the index course has reached a predetermined value.

It is advantageous, precisely for investments in investment funds, to specify annualized yield targets or to specify these with interest profits. This permits long-term yield targets to be tracked. The basic idea is to equip every contract type with yield target with an annualized or interest-related yield.

Since, in particular, the formula for the interest-related yield is unstable for short terms (i.e., small changes in performance generate great changes in the interest-related yield), the yield is either calculated with respect to purchase price or the average annual yield for run times that are shorter than one year. The following equation is based on day intervals but can also be modified for week intervals, etc., and is defined with the average annual yield for time spans shorter than one year:

Let (sₜ) be the result of all prices for a stock s at points in times in day t. Then let

$$R ( s , {t}_{0} , {t}_{1} ) = \frac{{S}_{{t}_{1}} - {S}_{{t}_{0}}}{{S}_{{t}_{0}}}$$

be the yield with respect to the purchase price Sₜ_{₀} at time t₀ as well as the current time t₁ with t₀<t₁.

The annualized yield is then calculated by

$${R}_{A} ( s , {t}_{0} , {t}_{1} ) = \{ \begin{matrix}\frac{{t}_{1} - {t}_{0}}{T} R ( s , {t}_{0} , {t}_{1} ) , {t}_{1} - {t}_{0} \leq T \\ ( 1 + R ( s , {t}_{0} , {t}_{1} ) ) \frac{T}{{t}_{1} - {t}_{0}} - 1 , {t}_{1} - {t}_{0} > T\end{matrix} ,$$

where T is usually set to 365 and T=366 only applies given leap years.

The Equation

$$\frac{{t}_{1} - {t}_{0} T}{T} R ( s , {t}_{0} , {t}_{1} ) , {t}_{1} - {t}_{0} \leq T$$

corresponds to an investment behavior that would sell the investment after the time period [t₀, t₁] and would forego a re-investment.

This calculating method is advantageous in order to also be able to evaluate short-term profits of security investments (investment period<one year) over the term of a year as well as to enable a comparison with risk-free investments with re-investment (for example, capital, etc.).

When the check of an annualized yield target is requested by the customer, the program module 16 is thus started that calculates the annualized yield, as indicated above, and compares this to the yield target. In general, investments precisely in the fund field can be “continuously” implemented. For example, shares of a fund can be acquired on a monthly basis with respect to a fixed investment sum, resulting in the investor acquiring many shares when the fund has a low price and fewer shares when the price is high. In general, the investor thus levels out price fluctuations (this effect is generally called the “cost-average effect”) and thus reduces investment risks. Equipping this investment method with the above-recited securing methods as well as the calculation of yield targets (with respect to purchase price or “annualized”) also makes it possible to secure this form of investment.

The basic idea is that the calculation of the yield of the accumulated investments at every purchase is time dependent on the basic investment. Purchase times can be flexibly handled and can be indicated at every possible time. In general, however, it is standard to select equidistant, monthly points in time given investments in funds (fund saving).

Every investment point-in-time is associated with a purchase sum as well as the number of shares.

It is advantageous that continuous investments can be monitored and secured with the above-described methods.

A general version for evaluating the performance of deposits is provided below that can be adapted to the requirements of fund-saving systems (regular purchase of securities). This is analogous to the calculation of index values such as the German stock index of the Deutsche Börse AG:

Let Sₖ(t) be the price of a security of a deposit position k at time t. Let the times again be given in daily resolution and let the price Sₖ(t) be the closing quotation of the stock (other time resolutions are possible). Let nₖ(t) be the number of stocks of the deposit position k at time t. The deposit value at time t is then calculated by

$$D ( t ) = {\sum }_{k} {s}_{k} ( t ) {n}_{k} ( t ) .$$

Problems in the calculation of the performance of the deposit are possible purchases or sales of deposit positions at specific points in time. Let these times at which the deposit changes be defined by t₁ . . . t_{N}. Let

$$D * ( t ) = {\sum }_{k} {s}_{k} ( t ) {n}_{k} ( t ) + {S}_{M} {n}_{M}$$

also be the modified deposit value at a purchase time by the addition of a further deposit position M at n_{M} units and a purchase price S_{M}.

Then let

i*(t)=max{i|i∈{1, . . . , N}Λtᵢ≦t} be the index of the most recent purchase time tᵢ and let K₀, . . . , K_{N} be chaining factors that can be recursively calculated by

$${K}_{1} = \frac{D ( {t}_{i} - 1 )}{D * ( {t}_{i} )} {K}_{i - 1} with {K}_{0} = 1.$$

A chained index time series can then be calculated by I(t)=K_{i*(t)}D(t)I.

The index time series I(t) must thereby be implicitly calculated via the recursively defined chaining factors Kᵢ with D(t)=1 for t<t₁, where I can assume an arbitrary value (for example, 1000 at the DAX) but should assume the most recent available overall purchase volume of all deposit positions in the calculation of the yield of the deposit.

When an entry is found in the customer data bank 3 for the appertaining security by which the yield target is to be checked on the basis of the deposit-specific index, the program module 8 is started in order to calculate the index I(t) according to the above-cited equation.

When the yield target has been achieved, the program module 7 starts the program module 9 for determining the yield-securing stop rate. When the yield target is reached for the first time, the appertaining price minus the tolerance is stored as yield-securing stop rate being stored in a memory of the computer 1 by the program module 9.

The corresponding security or customer deposit is subsequently located in the monitoring for securing the achieved market profits. During the course of further commerce, this means that security prices are monitored by the program module 9 to see whether these, minus the tolerance, lie above or below the previously stored profit-securing stop rate. When the current price or index value, minus the tolerance, lies above the previously stored profit-securing stop rate, then the current market price or index value, minus the tolerance, is deposited as a new profit-securing stop rate instead of the preceding one, and is deposited in the memory of the computer 1.

When, in contrast, the current market price or the current index value downwardly exceeds the preceding price or index value, then a check is carried out to see whether this downward transgression lies within the range of tolerance specified by the customer and stored in the customer data bank 3 (i.e., above the stop rate). When the downward transgression lies within the range of tolerance, then the previous profit-securing stop rate is retained; no action over and above this takes place.

When, in contrast, the tolerance range (i.e., the scope of fluctuation) is downwardly exceeded (i.e., the price or index value drops below the stop rate) then the program module 9 automatically generates a sell signal.

When the customer has indicated a stop loss rate, then the program module 10 checks for every new security price whether this stop loss rate has been reached or downwardly exceeded. When the stop loss rate is reached or downwardly exceeded, the program module 10 automatically outputs a sell signal.

The sell signal is generated by the program modules 9 and 10 can be output as automatic sell orders, these being output by the computer 1 via the network 12 to the server computer 14 or the corresponding fax machine, so that the sale of the appertaining security or securities is automatically carried out. Alternatively, the program module 11 is started that generates a work list that contains the sales to be made. This work list is displayed on the monitor 5 so that a user can process it.

The computer 1 can, for example, be utilized for commerce with stock funds. Given such stock funds, the take-back price is fixed on every trading day, for example at 2:00 p.m. or at 4:00 p.m. Fund shares can then be returned to the fund corporation at these daily quotations on the succeeding trading day. For this application, the server computer 13 calls the prices of the stock funds fixed by the market daily and these are evaluated by the evaluation program 6. Subsequently, a work list is generated with the program module 11 which is then capable of being processed by a user in that the user, for example, sends corresponding sell orders by telefax or online to the appertaining fund corporation or the appertaining online broker.

Preferably, the evaluation program 6 is configured such that it is started automatically at a specific point in time, for example, after the end of a trading day, in order to evaluate the daily quotations and generate a corresponding work list. The user of the computer 1 can then process this on the next morning.

Alternatively or additionally, the computer 1 can also be configured such that the commercial course of specific stocks and securities is tracked constantly in that the appertaining security prices are loaded by the server computer 13 as soon as they are available. The evaluation program 6 is then also started correspondingly frequently. For this application, which is time-critical due to the constant fluctuation of the prices, the direct electronic forwarding of a sell signal output by the program modules 9 or 10 to the server computer 14 is recommended.

FIG. 2 shows an embodiment of the customer data bank 3 of FIG. 1. One or more contracts are present for each customer in the customer data bank, these contracts being identified by the security identifier of the appertaining security, i.e., for example, of the stock or investment fund. The customer data bank contains the purchase price as well as the purchased time and the number of units of the purchased stocks or fund shares for every contract.

When the customer has indicated an absolute yield target, the data bank contains this yield target in percentages or as an absolute value referred to the price of the appertaining security or referred to an index value.

When the customer desires an annualized yield target, then this is likewise noted in the data bank. When the absolute yield target or the annualized yield target is to be checked with reference to the index course of the customer deposit, a corresponding entry is present in the data bank. Furthermore, the data bank contains a field for the profit-securing stop rate that is determined by the program module 9 (see FIG. 1). As warranted, the tolerance value requested by the customer is also input into this field.

The data bank also contains a field for inputting a stop-loss rate as well as a field for specifying whether a speculation term should be observed or not.

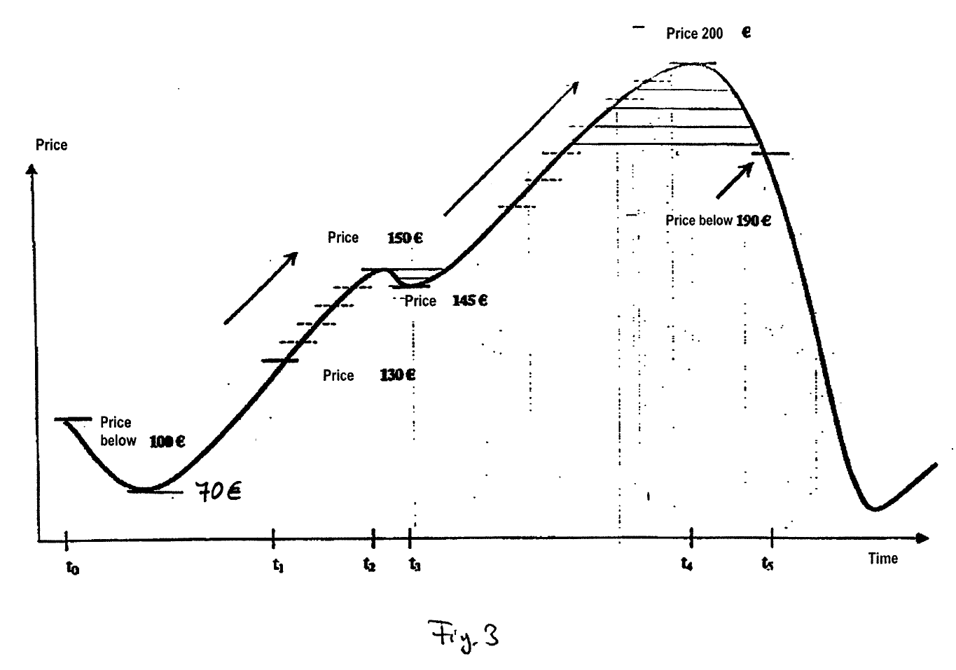

FIG. 3 illustrates the operation of one embodiment of the inventive method based pm the rate course of a specific security. The time is entered toward the right and the current price for the security is entered toward the top. At a time t₀, a specific unit number of the security is bought for a customer at a price of, for example, 100 euros via an investment consulting company.

This purchase is based on a corresponding contract with the customer which declares that an absolute yield target according to the rate course should be evaluated, and that market profits should be secured with a profit-securing stop rate. A stop-loss rate has not been declared, nor has observing a speculation term. The customer data bank 3 (see FIG. 1 and FIG. 2) serves the purpose of storing the appertaining contract parameters that have been input via the user interface 4 of the computer 1 (see FIG. 1).

A price of 130 euros has been declared with the customer as an absolute yield target. A fluctuation tolerance of 5% of the absolute yield target has been declared as a tolerance value for the deviation from the maximum of the rate course.

After the purchase at time t₀, the price initially drops, for example, until it rises again. At time t₁, the price has reached the absolute yield target in the amount of 130 euros. This is identified by the program module 15 and the program module 9 is started (see FIG. 1).

The price maximum of 130 euros that has been reached, minus the tolerance of 5% (6.5 euros), is then stored as profit-securing stop rate, i.e., a stop rate of 123.5 euros is entered in the data bank. The price continues to rise during the following time, so that the program module 9 continuously stores no profit-securing stop rates that respectively reflect the maximum quotation minus the tolerance.

At time t₂, the price reaches its initially highest value of 150 euros. This value minus the tolerance of 5% of this value, i.e. 142.5 euros, is then the current profit-securing stop rate at this time t₂.

Subsequently, the price drops again and reaches a value of 145 euros at t₃. Due to the dropping rate course, the profit-securing stop rate of 142.5 euros is maintained. The program module 9 (see FIG. 1) then checks whether the rate course is within the tolerance value, i.e., the fluctuation tolerance of 5% (above 142.5 euros). Since the change only amounts to 5 euros here, the fluctuation lies within the tolerance value so that no sell signal is generated.

After time t₃, the price again rises steadily until time t₄. Accordingly, the profit-securing stop rate is repeatedly adapted to the current price. After time t₄, the price of 200 euros drops to below 190 euros at time t₅. Since the last new profit-securing stop rate lies at 190 euros (200 euros minus 5% tolerance), the fluctuation tolerance to the amount of 5% has now been exceeded, so that a sell signal is generated by the system.

When the customer desires adherence to a speculation term, the time between the point in time of the purchase t₀ and the sale t₅ is additionally checked to see if it is longer than the speculation; the sell signal is generated when this is the case.

When the customer requests adherence to a stop loss rate of, for example, 80 euros, then this rate is entered in the customer data bank 3 and is constantly monitored by the program module 10 (see FIG. 1). In the exemplary case of FIG. 3 under consideration, this would result in a sell signal being generated immediately after the purchase, since the price drops below the stop loss rate, namely to 70 euros.

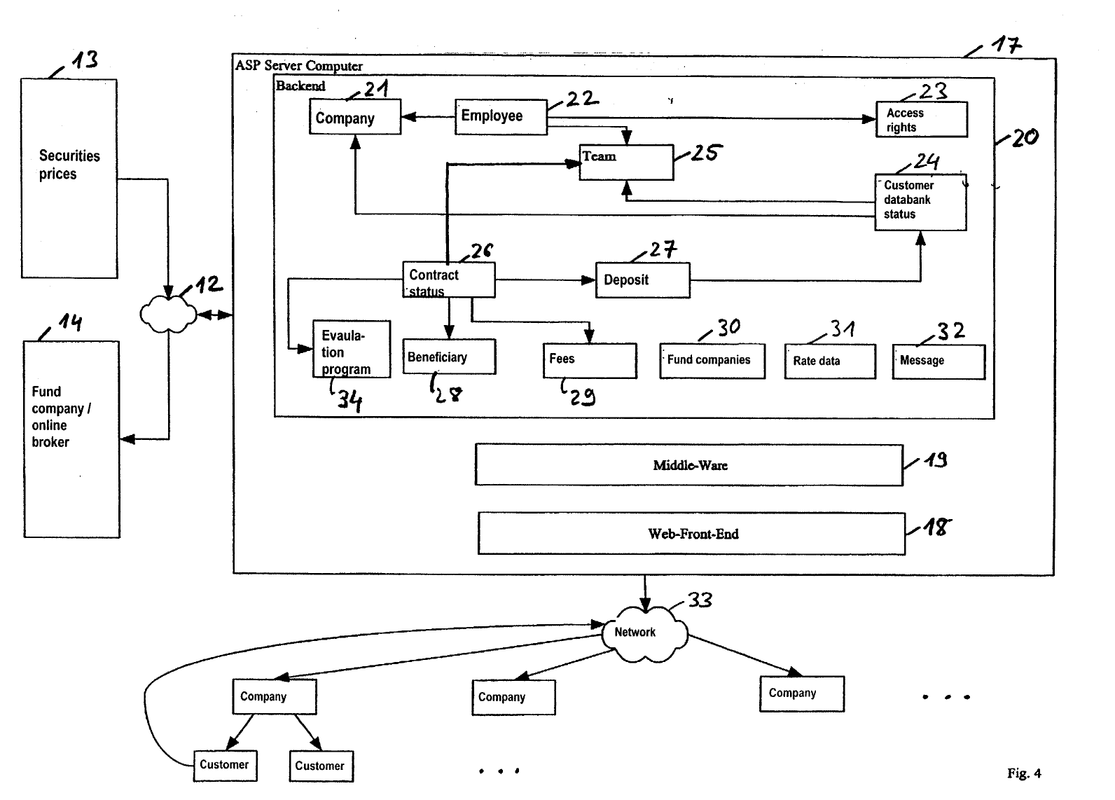

FIG. 4 shows another embodiment of an inventive computer system that uses an ASP.

The computer system contains an ASP server computer 17 that—similar to the embodiment of FIG. 1—is connectable to server computers 13 and 14 via a network 12 for querying security prices or for outputting sell orders.

The ASP server computer 17 contains a web front end 18 for generating web pages in order to make a user interface available. Furthermore, the ASP server computer 17 contains middleware 19, i.e., software components that are addressed via the user interface made available by the web front end 18. The ASP server computer 17 further contains a back end 20 having a data bank system. The data bank system, for example an SQL data bank, stores status information.

The data bank structures are encapsulated by the objects of the middleware, i.e., every user action is implemented on the middleware (the objects) and checked for consistency and errors. As soon as a status change is accepted by the middleware, this status is stored in the data bank. Statuses can thus be transferred from web page to web page, since, differing from classic programs, each generation of a web page generates a new server process that has no information about the “history” of the user interactions per se.

The workflow should furthermore be closely adapted to the workflow of the asset consultant so that actions that the consultant implements and declares with the customer can be imaged as closely as possible in the data bank. To this end, it is necessary to model all supported units as data bank object and encapsulate them with a corresponding object in the middleware.

For example, this modeling allows the definition of teams (account manager and consultant) who together handle contracts as well as customers in the system. Due to this flexibility, parameters are allocated to each “object”, i.e., each contract or customer, that later allow replication of who modified which object. Moreover, specific information can be allowed with specific units, for example, the members of a team who handle a specific customer, on the basis of these auxiliary parameters, but can be blocked for others.

The basic object modeling is described below by way of example.

In the ASP solution, various companies that are represented by data bank objects can be integrated. Employees are assigned to each company. An access right is allocated to each employee. This access right is either in ASP administrator, company administrator, consultant or account manager.

ASP-Administrator

The ASP administrator is responsible for the operation of the system and is generally allowed to monitor every process of a licensed customer as well as to intervene in statuses. Thus, an ASP administrator is allowed to:

add, delete or modify companies;

add, delete and modify employees of companies;

produce company statistics with respect to the customers and the concluded contracts;

have concluded contracts displayed;

view customer data, etc.

Company Administrator

The company administrator is responsible for all work sequences within a company and also serves as a monitoring entity with respect to the customer relationships: for example, the company administrator is allowed to

add, delete employees of this company or modify their master data;

view all customer contracts of his company; and

view statistics about employees (and their customers) of his company.

The company administrator must counter-sign requested monitoring contracts as well as confirm logons of customers of his company. The business manager of a consulting company is usually entered as company administrator.

Consultant

The consultant has direct customer contact and offers profit-securing contracts that are later inserted into the system to his (final) consumer. The consultant is allowed to:

log customers on for acceptance into the system;

request the deletion of customers; as well as

confirm contract applications as well as contract noticings.

In general, the consultant only has access to his own customers.

Account Manager

The account manager is linked to a consultant and prepares contracts of the final consumer in general that were communicated by the consultant and that must be confirmed in the system by the consultant.

Team Formation

Account managers and consultants can be joined as teams by the company administration. All information that relates to a part of the team are made available to the entire team.

Such an ASP solution allows the administration of multi-level access hierarchies and thus makes it possible that a plurality of companies having an arbitrary plurality of customers and employees as well as contracts can be administered at a central entity. Additionally, a workflow is defined that allocates clear responsibility of the users when dealing with the system.

This assures that all sell signals can be taken into consideration and that concluded contracts agree with the legal situation or derived responsibility situation that are usually (but need not be) administered outside the system. The comprehensive storing of all necessary parameters also assures that all investments that are placed in the system can be subjected to a comprehensive evaluation. Included here are evaluations that refer to various hierarchies (company, employee, final consumer).

In the embodiment of FIG. 4, the web front end 18 is supported on HTML as well as by dynamic web pages generated by the server (CGI or other programs). This corresponds to the classic client-server model in which a client (in this case, the consultant) triggers actions on the server via a respective user interface. In this system, the client need only have a computer with an Internet connection as well as a browser (HTML). The actions on the server are triggered by the user by calling web pages (via URL). The entire program execution is thus implemented on the server. The server may be composed of five different modules: company unit, employee unit, customer unit and the contract unit as well as a scanner (background process) that monitors the input contracts in view of potential sell signals.

An arbitrary plurality of companies can be administered in the company unit in the system. Each company contains employees (the client users) that are assigned to this company. In general, these employees can only access data of their allocated company. In turn, customers are allocated to the employees. Employees differ on the basis of four different, possible access rights (see above). On the basis of these assigned rights, the server decides what program flow and, thus, which information should be made available to the client (the employee).

The company administration can form pairs of employees (consultant and account manager) that respectively handle the customer as well as contracts together. Customers may be allocated to each employee from the customer unit. Each employee can only view or modify the customers or contracts assigned to him. Deposits may be allocated to each customer, these in turn containing the contracts (i.e. fund investments plus securing strategies) communicated from the consultant.

The various units may thus be strictly hierarchically oriented.

By specifying a company, a user name and a password, a client (employee) can log on at the system. The server can undertake an unambiguous identification on the basis of the company and employee unit. Moreover, the work environment may be adapted on the basis of the priority (access rights) of the employee.

Since, in particular, the customer data and the contract entries in the respective modules may be provided with status information, a work list can be produced by the server after the log on of the employee. Account managers and consultants can be presented with customer entries as well as contract entries that have not yet been confirmed (that are yet to be confirmed) as well as with current contracts accepted for monitoring by the scanner unit as well as sell positions that have been signaled.

In contrast to this, company administrators may also be presented with customer or contract applications to be confirmed and customer deletions or contract nullifications. In addition, the company administrator, by passing the four-eye principle, receives messages of his employees, i.e., whatever contract or customer applications are confirmed by the consultant himself, the system sends a message to the company administrator.

In the exemplary case of FIG. 4, the back end 20 contains a company unit 21 for storing the master data of various company customers of the ASP. The companies typically comprise asset and investment consulting corporations.

The back end 20 also contains an employee unit 22 for storing master data of employees as well as access data such as user name and password as well as a pointer to the access rights unit 23 for defining the role of the appertaining employee. Every employee covered in the employee unit 22 is assigned to a specific company of the company unit 21.

The ASP administrator can add a company to the company unit 21 as well as input a company administrator for this company as an employee in the employee unit 22. A pointer to the access rights as company administrator may be generated for the appertaining employee of the company. The company administrator can then employees of his company to the employee unit 22 and assign access rights.

The back end 20 also has a customer unit 24. Each customer entry, in addition to containing the master data, contains the company affiliation, the allocation to a team (groupings of consultant and manager) of the team unit 25, the status information as well as the employee who prepared the customer dataset and that employee who most recently modified the customer dataset. A customer dataset can generally be called only by employees that belong to the indicated team or have administrator authorization. This means that the customers within a company are separated among the various consultants.

The status information indicates what should occur with the customer dataset in the workflow. In an exemplary embodiment, REGISTERED marks the dataset as input, and signals the system that this dataset should be displayed to the company administrator for correction or confirmation. When the company administrator corrects or confirms this dataset, the status information is raised to CONFIRMED. Contracts (fund investments) can only be assigned to customers when these have the status information CONFIRMED or CHANGED. This status information is set to CHANGED when the customer dataset was manipulated. When a consultant or account manager logs customers on for deletion, the status information is set to CHECKOUT. No further contracts, etc., can now be assigned to the customer. This requested customer deletion is in turn presented to the company administrator who can confirm this (CHECKOUTCONFIRMED).

The back end 20 also contains a contract unit 26. As described above, various contract modalities are supported by the system. The contract unit contains various parameters that describe the respective contract versions in specific combinations.

All contracts are assigned to a deposit and contain a securities identifier that refers to the security to be purchased. Furthermore, a company as well as a team of this company are allocated to the contract, these being notified by the system when the contract is noticed. Analogous to customers, contracts are equipped with a status information as well as with a reference to the status-modifying employee. When a contract is logged on in the system by an employee (i.e., presented in parallel to the business management for signature), then the contract is correspondingly marked with REGISTERED. Contracts marked as REGISTERED are presented to company administrators by the system for confirmation. As a result of the confirmation of the company administrator, the contract is identified as CONFIRMED.

Only contracts that have a higher priority than REGISTERED are monitored. These contracts to be monitored are checked at certain points in time by the monitoring module dependent on the type of contract. When, for example, contracts reach their yield target, then the contract is equipped with a stop rate and is also identified with the status information ACTIVATED. Contracts that have been identified with ACTIVATED are signaled to the respective team as being activated, so that the account manager or the consultant can send a message to the customer (automatic sending of a notification is not precluded). When a team member confirms this presentation of the system, then the status MONITORED is set. Profit securing can only begin when the status of the contract is ACTIVATED or MONITORED.

When a check shows that the contract should be set to sell because, for example, a profit-securing stop rate has been downwardly exceeded (profit securing), then the system marks this contract with TERMINATED. Contracts having this status information are again displayed to the team members. As soon as the fund shares have been sold, the team members must confirm this notification, so that the contract is marked as CHECKOUT and is presented to the company administration for confirmation.

A contract of the contract unit 26 can be linked with a deposit of the deposit unit 27 as well as with the beneficiary unit 28 and the fee unit 29. The beneficiary unit 28 serves the purpose of storing the persons benefited by the contract; the fee unit 29 serves the purpose of debiting the fees charged by a company, for example, for activating a sale.

The back end unit 20 also contains a fund company unit 30 for storing the master data of fund companies by which sales are to be activated and also contains a rate data unit 31 for storing current rate data that have been communicated from the server computer 13.

The notification unit 32 of the back end 20 serves the purpose of generating internal messages when, for example, an employee has himself activated a contract bypassing the four-eyes principle.

The customers 46 of the company—just the like the companies via their computers 45—can communicate with the ASP server computer 17 via a network 33, for example, the Internet. Furthermore, the ASP server computer 17 can be configured such that the customers of the appertaining companies can also directly communicate with the ASP server computer 17 via the network 33 in order, for example, to query the processing status, current price data, and sell signals.

Among other things, the evaluation program 34 accesses the contract unit 26 and has a functionality analogous to the evaluation program 6 of the embodiment of FIG. 1.

The present invention has been described in terms of functional block components and various processing steps. Such functional blocks may be realized by any number of hardware and/or software components configured to perform the specified functions. For example, the present invention may employ various combinations of hardware or software elements, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, control, data processing and the like.

The particular implementations shown and described herein are illustrative examples of the invention and are not intended to otherwise limit the scope of the invention in any way. For the sake of brevity, conventional electronics, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical sensor device. Moreover, no item or component is essential to the practice of the invention unless the element is specifically described as “essential” or “critical”. Use of the word “mechanism” is not intended as being limited to defining physical structure or entity, but can also be interpreted as a software implementation and/or methods.

[image]

[image]

[image]

[image]

[image]

[image]

[image]

[image]

[image]

[image]

[image]

What is claimed is:

1. A computer system for securing market profits of financial instrument investments comprising:
a storing mechanism configured to electronically store a yield target for a purchased financial instrument species;
an acquisition mechanism configured to electronically acquire a current rate of the instrument species;
a calculation mechanism configured to calculate a yield of the purchased financial instruments and to compare the calculated yield to the yield target,
wherein the calculation mechanism is configured to:
implement, if necessary, one or more recalculations and recomparisons with rates respectively newly acquired by the acquisition mechanism until the calculated yield is higher than the yield target;
store, given a first-time and every further occurrence of this case, the calculated yield target as a new yield target in the storing mechanism and, if necessary, implement one or more recalculations until the calculated yield is lower than a respective, new yield target and does not lie within a tolerance value;
the computer system further comprising:
an output configured to provide an instruction to sell the instrument species when the calculated yield is lower than the new yield target and does not lie within a tolerance value.

2. The computer system according to claim 1, wherein the output is configured to provide the instruction to sell only when a predetermined time interval following the purchase has elapsed.

3. The computer system according to claim 1, wherein the calculation mechanism further comprises:
an annualized yield calculator that is configured to calculate an annual yield either with respect to a purchase price of the purchased instrument species or an average annual yield for run times that are shorter than one year.

4. The computer system according to claim 1, further comprising:
an index calculator configured to calculate an instrument index for instruments of a customer deposit, such that an index curve is steady given a purchase or sale of an instrument, and wherein the calculation mechanism is configured to access the index curve as a test criterion.

5. The computer system according to claim 1, further comprising:
a minimum checking mechanism configured to check whether a prescribed minimum of a rate curve has been reached; and
a sell signal output configured to output a sell signal when the minimum has been reached.

6. The computer system according to claim 1, further comprising an input configured to input at least one of the following elements in view of a stock: a purchase price, a time of purchase, a number of units, an absolute yield target, an annualized yield target, a checking mechanism configured to check a yield target with reference to an instrument index; a maximum of a rate curve after a yield target has been reached, a prescribed minimum of the rate curve, and a speculation term, wherein a mechanism for determining a maximum of the rate curve are configured to access the data bank in order to store a maximum of the rate curve.

7. The computer system according to claim 1, wherein at least one of the storing mechanism, the acquisition mechanism, and the calculating mechanism are is a component part of a computer.

8. The computer system according to claim 7, further comprising:
a quote server computer configured to offer instrument quotes;
a sell-order output server computer configured to output sell orders, wherein the quote server computer and the sell-order output server computer are connectable to the computer via a network.

9. The computer system according to claim 1, further comprising:
a web page generator configured to make a user interface available;
a user group storage mechanism configured to store user groups having access rights assigned to each user;
an administrator user input mechanism configured to input a user of a user group as an administrator, wherein the administrator can input users of the user groups and their access rights.

10. The computer system according to claim 1, further comprising:
a customer data input mechanism configured to input customer data by which each customer is assigned to a pair of users of a same user group;
a contract data input mechanism configured to input contract data by which each contract is assigned to a pair of users of the same user group;
a process status generator configured to automatically generate a processing status for the customer data and the contract data; and
a work list generator configured to generate work lists based on the processing status for each of the users.

11. The computer system according to claim 10, wherein at least one of the customer data input mechanism, the contract data input mechanism, the process status generator, and the work list generator is a component part of a server computer.

12. The computer system according to claim 11, wherein the server computer is an application service provider (ASP) server computer.

13. A computer system according to claim 1, further comprising:
a quote server computer configured to offer instrument quotes; and
a sell-order output server computer configured to output sell orders, wherein the quote server computer and the sell-order output server computer are configured to be connected to an ASP server computer via a network.

14. A computer system according to claim 13, further comprising:
at least one computer of a bank or financial institution that can be connected to the ASP server computer via the network.

15. A computer system according to claim 14, wherein the ASP server computer is configured to allow at least one customer of the bank or financial institution to communicate directly with the ASP server computer via the network.

16. A method for securing market profits of financial instrument investors using a computer, comprising:
a) electronically storing a yield target for a purchased financial instrument species;
b) electronically acquiring a current rate of the instrument species; and
c) calculating a yield and comparing the calculated yield to the yield target and,
when the calculated yield is lower than or of the same size as the yield target, repeating b) and c);
otherwise
a′) electronically storing the calculated yield as a new yield target;
b′) electronically acquiring a current rate of the instrument species; and
c′) calculating the yield and comparing the calculated yield to the new yield target, and
when the calculated yield is higher than the new yield target repeating a′) through c′);
when the calculated yield is lower than the new yield target but lies within a tolerance value
retaining the yield target and repeating steps b′) and c′); and
when the calculated yield is lower than the new target yield and does not lie with a tolerance value
outputting an instruction to sell the instrument species.

17. The method according to claim 16, wherein at least one of b) and b′) is performed at regular time intervals.

18. The method according to claim 16, wherein at least one of b) and b′) is performed at irregular time intervals.

19. The method according to claim 16, wherein at least one of b) and b′) entails automatically obtaining the current rate.

20. The method according to claim 16, wherein at least one of b) and b′) utilizes a push technology.

21. The method according to claim 16, further comprising:
calculating an annualized yield, where the annualized yield for run times that are shorter than one year is calculated either with respect to a purchase price of a purchased instrument species or an average annual yield is calculated.

22. The method according to claim 16, further comprising:
calculating an index of an instrument for instruments of a customer deposit,
wherein the index calculation is performed such that an index curve is steady given a purchase or sale of an instrument.

23. The method according to claim 16, further comprising:
inputting a user of a user group as an administrator into a data bank of a server computer;
assigning the administrator a right to input users of his user group and appertaining access rights;
inputting customer data;
assigning each customer to a pair of users of a same user group;
inputting contract data;
assigning each contract to a pair of users of a same user group;
automatically generating a processing status for the customer data and the contract data;
generating work lists based on the processing status for each of the users.

24. The method according to claim 23, wherein the server computer is an application service provider (ASP) server computer.

25. A computer configured to execute computer code that implements the method elements of claim 16.

26. A computer program product containing computer code that implements the method elements of claim 16.

27. The computer program product according to claim 26, wherein the computer program product comprises a data carrier containing the computer code.
